(19) United States
(12) Patent Application Publication
(10) Pub. No.: US 2004/0170179 A1
(43) Pub. Date: Sep. 2, 2004

(54) Radio resource management with adaptive congestion control

(76) Inventors: Klas Johansson, Sundbyberg (SE); Mikael Hellstrom, Huddinge (SE)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/373,710

(22) Filed: Feb. 27, 2003

(51) Int. Cl. H04L 12/56

(52) U.S. Cl. 370/395.2; 370/230

(57) ABSTRACT

The invention is a method for scheduling the transport of downlink data packets in a radio access bearer for a non-real-time (NRT) data transport service. The invention adapts the scheduled bit rate of the Radio Access bearer to the bit rate value that the radio interface (Uu) can currently provide and comprises the steps a) ascertaining an upper limit of a bit rate value that the radio interface comprised by the radio access bearer is currently able to provide for said NRT data transport service, and b) scheduling the downlink data packets in the radio access bearer with a bit rate smaller than or equal to the bit rate upper limit value.

### CROSS-REFERENCE TO RELATED APPLICATION

This application claims the benefit of the filing date of Provisional Application ______ (Attorney Docket No. 1120.42507L00), entitled “Radio Resource Management With Adaptive Congestion Control”, filed on Feb. 19, 2003.

### BACKGROUND OF THE INVENTION

1. Field of the Invention

This invention is in the field of Radio Resource Management (RRM), more particular, in the field of packet scheduling. The invention concerns a method for controlling at least one Radio Access Bearer parameter of a first Radio Access Bearer (RAB), and a Radio Access Bearer Control unit. It also concerns a radio access network element.

2. Description of the Prior Art

Radio Resource Management (RRM) algorithms and devices are designed to fulfill predetermined Quality of Service (QoS) requirements for individual radio connections while still maximizing the total system throughput under high load conditions.

With the introduction of a broad range of services and with the introduction of classes providing different QoS in mobile communication systems, differentiating the service offerings to the customers is of increasing importance to the operators.

In UMTS, four QoS classes are defined: conversational class, streaming class, interactive class, and background class. The main distinguishing factor between these QoS classes is the sensitivity to a delay in the traffic. The conversational class is meant for traffic which is very delay-sensitive while the background class is the most delay insensitive traffic class.

The conversational and streaming classes are mainly intended to carry real-time traffic flows. Real-time (RT) services do not tolerate much transport delay and are always preferred over non-real-time (NRT) services. RT services are not involved in the packet scheduling performed by the packet scheduler. They are not concerned by the present invention.

Interactive class is mainly meant to be used by traditional Internet applications like World Wide Web (WWW) browsing. Background class traffic comprises E-mail, short messages, Telnet, File Transfer, Chat, and News. Due to looser delay requirements,compared to conversational and streaming classes, both provide a better error rate by means of channel coding and retransmission. It is only NRT services like the ones comprised by these service classes with which the present invention is concerned.

The Radio Resource Management function comprises Power Control (PC), Handover Control (HC), Congestion Control, and a Resource Manager (RM).

The present invention deals with Congestion Control. Congestion Control is typically subdivided into Admission Control (AC), Load Control (LC) and Packet Scheduling (PS). Admission Control, together with Load Control and Packet Scheduling ensures that the network stays within the planned condition. Load control manages situations when system load has exceeded given thresholds and some countermeasures have to be taken to get the system back to a feasible load.

Packet Scheduling handles all non-real-time (NRT) traffic. It decides when a packet transmission is initiated and the bit rate to be used.

Admission Control (AC) performs the functionality of mapping Radio Access Bearer (RAB) parameters onto Radio Bearer (RB) parameters at the setup of a connection, or when the RAB parameters are re-negotiated. That is, RB parameters are decided from Radio Access Bearer (RAB) parameters of the desired service.

A bearer is a logical connection with specific capabilities offering a set of services, called bearer services, between the end points of the bearer. In the Universal Mobile Telecommunications System (UMTS), a UMTS bearer service comprises a Radio Access Bearer (RAB) service and a CN Bearer service.

The CN Bearer Service provides transport of signalling and user data between an lu Edge Node in a CN and a CN Gateway. lu designates the interface between a CN and a RAN.

The Radio Access Bearer (RAB) Service provides transport of signalling and user data between a mobile terminal (MT), also called user equipment (UE) hereinafter, and a CN lu Edge Node. The RAB parameters decide the QoS between the Core Network and the UE in the UMTS architecture. The packet scheduling in a UTRAN is based on, among other things, RAB parameters which are agreed with the CN at RAB setup.

A RAB service consists of a Radio Bearer (RB) service and an lu Bearer service. A RB is a bearer provided between a UE and a Radio Access Network (RAN), that is, in UMTS, a UTRAN (Universal Terrestrial RAN) or a GERAN (GSM Edge RAN). The role of the Radio Bearer Service is to cover all the aspects of the radio interface transport. Radio Bearer (RB) parameters decide the QoS for a radio connection. The lu-Bearer Service provides the transport between the UTRAN and the CN.

In high-load situations, the radio interface represents a bottleneck for data transport between the CN and the UE. In the UTRAN, Radio Link Control (RLC) buffer memory is located at the RNC to transiently store downlink data to be transmitted to the UE via the radio interface. The RNC is directly connected to the CN via the lu interface and represents a central node that is remote from the radio interface between the UE and a Node B, which allocates transport resources of a particular base station to the UE. Thus, in the UTRAN, if one base station is heavily loaded, memory and processor load can be efficiently shared between different processors in the RNC. This implies strong variations of buffer load and processor load at the RNC. The RNC has to be provided with a high buffer and processing capacity to be able to adapt to heavy-load situations.

For future RANs, a distributed RAN architecture is proposed in the framework of the Third Generation Project Partnership (3GPP). Such a distributed RAN architecture earlier has also been given the name IP-RAN. In a distributed RAN architecture the functionality of the RNC is distributed to each Node B+, also called IP-Base Transceiver Station (IP-BTS) in earlier terminology. A Node B+ is a base station that includes some of the functionality which would be provided by the RNC in a UTRAN. Among the functions performed by the Node-B+ are Radio Link Control and Radio Resource Management. This means that the distributed RAN architecture does not provide sharing of memory and processor load at one central radio access network node in a high-load situation.

This has disadvantages especially in situations where a UE is in soft handover. A UE in soft handover is connected to more than one Node-B+ simultaneously. These Node-B+ nodes form a soft-handover active set for the given UE. All downlink traffic is sent to all Node-B+ nodes in the active set, which each are responsible for buffering. To some extend, this can be compensated by an anchoring of the Serving Node-B+. That means, one particular Serving Node-B+ is selected for providing transport resources to a UE in order to avoid duplication or multiplication of data in soft handover. This can reduce the transport network load in a distributed RAN architecture as compared to UTRAN.

However, anchoring of the Serving Node-B+ alone cannot compensate the lack of a shared central buffering capacity in a high-load situation. While especially an anchoring Node-B+ needs additional memory for RLC buffers etc. this is also true for every other Node-B+ that must be provided with a relatively high RLC-buffer memory capacity. Distributed buffering is one reason for a high variance of the transport network load. This is one factor responsible for temporary congestion in the transport layer, making it difficult to reliably reserve transport resources between the Serving Node-B+ and the CN.

### SUMMARY OF THE INVENTION

The invention provides a radio resource management method that allows reduction of the buffer memory capacity in a RNC or an Node-B+.

The invention also provides a radio resource management method that reduces the variance of the transport network load in a centralized as well or in a distributed RAN architecture.

The invention also provides a Radio Bearer Control unit for controlling at least on radio bearer parameter, that provides a tool for a radio network operator allowing providing of a requested quality of service also at higher system load.

The invention also provides a radio access network node that allows implementation of the method of the invention.

According to a first aspect of the invention, a method for scheduling the transport of downlink data packets in a radio access bearer for a non-real-time (NRT) data transport service is provided. The method of the invention comprises the steps of

ascertaining a bit rate value that a radio bearer comprised by the radio access bearer is currently able to provide for the NRT downlink data transport service, and

scheduling the downlink data packets in the radio access bearer with a bit rate smaller than or equal to the maximum bit rate.

The method of the invention is based on less buffering being required at the Node-B+ if the scheduled bit rate for NRT services in the downlink in a radio access bearer is kept close to the bit rate that the radio interface is currently able to provide. In contrast to the prior art, the method of the invention provides a control mechanism of the scheduled bit rate.

The radio interface load is preferably defined on a per-cell basis. However, the radio interface load may also be defined on the basis of all cells belonging to a Node-B+ or RNC, or on the basis of all cells sharing the same transmission link in the “last mile”. The invention breaks with the practice of scheduling the bit rate in a radio access bearer (RAB) in the packet scheduler according to a fixed scheduling rate that is determined by the RAB paratemter “Maximum Bit Rate”. According to prior art, this parameter is agreed upon between the radio access network and the core network at the setup of the RAB and kept constant for the complete time span the RAB exists. In contrast thereto, the method of the invention adapts the scheduled bit rate for a RAB at the setup and during the whole time that the RAB exists.

The adaptation comprises a step of ascertaining a bit rate value that a radio bearer comprised by the radio access bearer is currently able to provide for the NRT data transport service. Ascertaining involves in a preferred embodiment initiating and performing a measurement of the radio interface downlink load. The uplink load is not relevant for the present invention. The downlink load of the radio interface involves the RT and NRT downlink loads, plus signalling. In an alternative embodiment, the upper limit of a bit rate value that the radio interface comprised by the radio access bearer is currently able to provide for the NRT data transport service is ascertained based on a measured throughput value.

The bit rate value that a radio bearer comprised by the radio access bearer currently is able to provide for a NRT data transport service (in short hereinafter: bit rate value) is in a preferred embodiment ascertained individually with respect to one or more respective service classes. The ascertaining step is in one embodiment performed for one RAB individually. In this case, only the bit rate value for the requested service class of this particular RAB is ascertained. In an alternative embodiment, bit rate values for all defined service classes are ascertained centrally to be available for all current RABs. In this alternative case, the bit rate value used for an individual RAB corresponds to the bit rate value currently requested service class for that RAB.

In the following, several embodiments for embedding the method of the invention into a network environment providing differentiation of services are explained. The bit rate values to be ascertained according to the method of the invention can be distinguished, for instance, according to a traffic class. NRT traffic classes defined in current 3GPP standards are either ‘interactive’ or ‘background’, as mentioned above. Of course, any other classification is possible, such as only one NRT traffic class or more than two NRT traffic classes, e.g., according to a decreasing delay sensitivity.

Alternative ways to distinguish different service classes in the ascertaining step comprise differentiating between different Allocation/Retention Priorities or Traffic Handling Priorities. The Allocation/Retention Priority is a RAB service attribute parameter that specifies the relative importance compared to other UMTS bearers for allocation and retention of the UMTS bearer. The Traffic Handling Priorities specifies the relative importance for handling of all Service Data Units (SDUs) belonging to a particular UMTS bearer compared to the SDUs of other UMTS bearers.

The load can be expressed as a current value of a bit rate parameter, or a power parameter, and is defined in relation to a known maximum value of the particular load parameter given by the physical contraints of the radio interface. Examples of downlink load parameters are defined in J. Laiho, A. Wacker, T. Novosad, “Radio Network Planning and Optimisation for UMTS”, Wiley, West Sussex, England, 2002, pages 178 to 180.

From the current load parameter, the remaining radio interface capacity can be estimated and translated into an upper limit value of a bit rate that may be scheduled by the packet scheduler for a given Radio Access Bearer.

The scheduling takes place in the core network, in particular at the edge node of the core network. By scheduling with a bit rate that does not exceed the maximum bit rate that the radio interface is currently able to provide, data congestion at the Node-B+ is avoided as much as possible in the method of the present invention. Since the Node-B+ receives downlink data for the radio bearer of the particular RAB on one end thereof at a rate that Node-B+ is able to accomodate in the radio transmission to the UE at the other end, the queue at the Node-B+ is kept short. This allows reduction of the total RLC buffer capacity at the Node-B+.

The method of the invention is not restricted to a use in a distributed RAN architecture. In the known “centralized” RAN architecture with a separate RNC and Node-B, by applying the method of the invention the dynamics of the buffer and processor load variations are lowered and a lower average buffering and processing load is achieved. This allows reduction of the buffering and processing capacity of an RNC, or to use existing capacities for improving the performance of the RNC.

In a distributed RAN architecture, by applying the method of the invention, the variance in the transport network load above the Node-B+ is reduced. The maximum bit rates assigned to the currently existing RABs reflect the current load situation of the radio interface. In a high-load situation, the assigned maximum bit rates are lower than in a normal or low-load situation.

At high load, buffering is split between the CN and the Serving Node-B+. This reduces the buffer load in the Node-B+ and makes anchoring less needed for hardware resource sharing between different Node-B+ nodes. This in turn enables faster channel type switching between CELL_FACH and CELL_DCH, and less use of framing protocol connections between Node-B+ nodes. A faster channel type switching improves the performance especially for low-bit-rate streams and with bursty data.

It is an important feature of the method of the present invention, that the invention is applied any time during the setup of the RAB or over the duration of the RAB. Even by applying the method only once during the setup of the RAB, there is an advantage over prior art methods, because the scheduled bit rate of the particular RAB then reflects the load situation at the beginning of the connection, and not a global preset parameter. In a high-load situation a new RAB is assigned a lower maximum bit rate than previous RABs. This helps to reduce the radio interface load.

In a preferred embodiment of the invention, the method is performed repeatedly during the duration of the RAB. By repeatedly performing of the method of the invention, the scheduled bit rate of a RAB is adapted to the respective momentaneous load of the radio interface. If the load is decreased, the scheduled bit rate can be increased to reflect the new peak bit-rate that is feasible. It the load is increased, so that the allocated bit rates in the radio interface are decreased, the bit rate scheduled by the packet scheduler should be lowered. This embodiment introduces a tuning of the bit rate scheduled by the packet scheduler in the core network. The tuning is based on a current upper limit value of the bit rate to be scheduled.

Preferably, this embodiment of the method of the invention involves performing the method with a repetition rate that can be predetermined. That means, the method is repeated after a predetermined time interval to adapt the scheduling to the new load situation at the given point in time. On one hand, the higher the repetition rate, the more accurate is the current load estimate, and the better is the control of the radio interface load with respect to congestion at the IP-BTS. On the other hand, the signalling involved in the ascertaining and scheduling steps increases with an increase in the repetition rate. Also, at a high repetition rate of the method congestion control becomes sensitive to spurious peaks of the radio interface load that need not be accomodated by adjusting the transport load to the IP-BTS. Therefore, it is preferred to adjust the upper limit rate for scheduling on a slow basis. As a general guideline, the time span between two control steps can be in the range of tens of seconds to a few minutes. It is obvious, however, that the time span chosen depends on the network parameters of the individual network and the load characteristics of the air interface.

With the adaptation according to the present embodiment of the invention, the scheduled bit rate can most of the time be kept below or equal to the bit rate that the radio interface is currently able to provide, as determined in the ascertaining step. The radio interface, as explained earlier, represents a bottleneck in the transport of data from the core network to the UE. However, when the radio interface load decreases, the scheduled bit rate of a RAB should be increased in order to enhance the quality of service and to make optimal use of the transport network capacity.

While a step of measuring a parameter representing the current radio interface load may be included in one the embodiments of the method of the invention, an alternative and preferred embodiment comprises requesting a measured value of a parameter representing the current radio interface load. In this preferred method, the measuring step is performed by a network element that operates independently of the method of the present invention and provides its data to other network entities requesting them. This embodiment is preferred because the current radio interface load is the same for all active RABs, and there is no need to perform measurements for each RAB.

In a further preferred embodiment of the invention the ascertaining step comprises determining a mean value of a plurality of previously ascertained maximum bit rate values. The averaging period for scheduled bit rates should be sufficiently long so that short periods of high load do not lower the average throughput. In a further embodiment an additional step of determining a variance of the plurality of previously ascertained bit rate values is performed.

The ascertaining step comprises in a further embodiment of the method of the invention the evaluation of the statistics of previously allocated bit rates. Allocated bit rates may vary from ascertained bit rates. The scheduled bit rate is in this embodiment based on the evaluation of these statistics alone, rather than on a current measurement.

In a further preferred embodiment of the invention, the scheduling step comprises an additional step of settting a “Maximum Bit Rate” parameter for the given service class smaller than or equal to the maximum bit rate value. This step involves a global setting that applies for all active radio access bearers of the given service class. The “Maximum Bit Rate” parameter is a RAB parameter well known in the art. It is defined as the maximum number of bits delivered by the UMTS and to the UMTS at a service access point within a period of time, divided by the duration of the period. It is primarily used to define the upper limit of the bit rate for RABs. In addition, however, like all RAB parameters, it can be used for the determination of RB parameters in a parameter mapping procedure during setup of a new RB. The RAB parameter “Maximum bitrate” is in the prior art the maximum bit rate that a UE can support. Hence in the known RRM algorithms, i.e. the Packet Scheduler, there can not be allocated a higher or lower bit rate than this to a specific UE.

This embodiment has the advantage that it is particularly easy to implement, because known packet scheduling methods rely on the “Maximum Bit Rate” parameter value in setting their scheduled bit rate for a RAB during a negotiation between the RAN and the ON.

Therefore, preferably after the setting step, a step of providing the current “Maximum Bit Rate”-parameter value allocated to the given service class of the radio access bearer is performed as an input to the scheduling step, such that scheduling the downlink data packets in the radio access bearer is performed with a bit rate smaller than or equal to the “Maximum Bit Rate” parameter value.

The ascertaining and scheduling steps are preferably performed in dependence of a data transport service type and/or a user class allocated to the radio access bearer. The term data transport service type relates to the service class defined earlier. A service class may be further differentiated according to the service type. For instance, the background service class comprises SMS messaging and e-mail messaging as different data transport service types.

According to a second aspect of the invention, a radio access network node is provided, comprising a monitoring unit which measures a current value of a load parameter of an radio interface and a signalling unit which transmits a signal corresponding to the current value to at least one core network node connected with the radio access network node.

The radio access network element of this aspect of the invention performs the measurement that provides an input for the ascertaining step of the method of the first aspect of the invention.

In a preferred embodiment the monitoring unit performs the measurement with a repetition rate that can be predetermined.

In a further preferred embodiment the radio access network node comprises an evaluation unit which calculates a value of the “Maximum Bit Rate” RAB parameter from the determined radio interface load parameter.

According to a third aspect of the invention, a core network node is provided comprising a packet scheduler which schedules downlink data packets allocated to a given radio access bearer for a NRT data transport service with a bit rate smaller or equal to a maximum bit rate allocated to the radio access bearer, wherein the packet scheduler ascertains a bit rate value that can currently be provided by a radio bearer comprised by the radio access bearer for the NRT data transport service, and to schedule the downlink data packets in said radio access bearer with a bit rate smaller or equal to the maximum bit rate.

### BRIEF DESCRIPTION OF THE DRAWINGS

FIG. 1 shows a flow diagram of an embodiment of the method of the invention;

FIG. 2 shows as a first embodiment of a network element of the invention a schematic block diagram of a RNC in a centralized UTRAN network architecture;

FIG. 3 shows as a second embodiment of a network element of the invention a schematic block diagram of a Node B+ in a distributed RAN architecture.

### DESCRIPTION OF THE PREFERRED EMBODIMENT

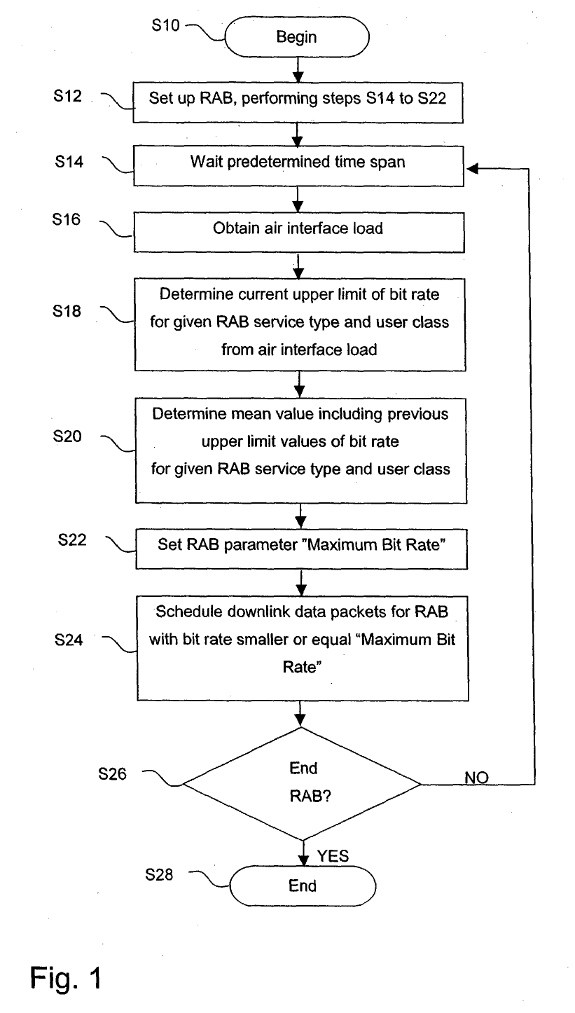

A preferred embodiment of the method of the invention is shown as a flow diagram in FIG. 1. The method of FIG. 1 serves to control the RAB parameter “Maximum Bit Rate” according to the current bit rate, that the radio interface is able to provide for the given service type and user class.

The method starts with a step S10. At a step S12, a RAB is set up. The set up of the RAB follows procedures known in the art, except for the negotiation of the RAB parameter “Maximum Bit Rate”. This parameter is obtained in the present method according to the method steps S16 to S22 described below. In order to keep the diagram simple, steps S16 to S22 are not included twice in the method flow. After having negotiated the “Maximum Bit Rate” according to steps S16 to S22 within the set up procedure of the RAB according to step S12, scheduling of downlink data packets is performed according to step S24, which is also described in detail below. Again, for reasons of simplicity of the representation in the flow diagram, step S24 is not shown a second time in the context of the RAB set up of step S12.

Scheduling of downlink data packets continues while waiting step S14 is performed. The waiting step serves to secure a predetermined repetition rate of performing the method.

After the preset time span waiting for a new value of the radio interface load is obtained in a step S16. From this value, in a step S18, the current upper limit of the bit rate is estimated, that the radio interface is able to provide for the given service type and for the user class allocated to the UE at the end point of the RAB. In a step S20, a mean value is calculated using the value determined in step S16 and a preset number of previously obtained upper limits of the bit rate for the given service type and user class.

The calculated mean value is used to replace the value of the RAB parameter “Maximum Bit Rate” in a step S22. This is done in a negotiation procedure between the RAN and the CN which is known per se. However, according to the present method the value of the “Maximum Bit Rate” is negotiated even for an active RAB. This re-negotiation only takes place if the mean value determined in step S20 differs from the currently set “Maximum Bit Rate” value by a at least a preset threshold percentage. Minor differences do not lead to a re-negotiation in order to save unefficient signalling between the RAN and the CN.

After the negotiation in step S22 the packet scheduler uses the new value of the “Maximum Bit Rate” for determining the scheduling rate in the NRT packet download link through the RAB.

Unless there is a command to end the RAB service, (steps S26, S28) the method branches back from step S26 to step S14 to wait for the next cycle of controlling the value of the “Maximum Bit Rate” parameter.

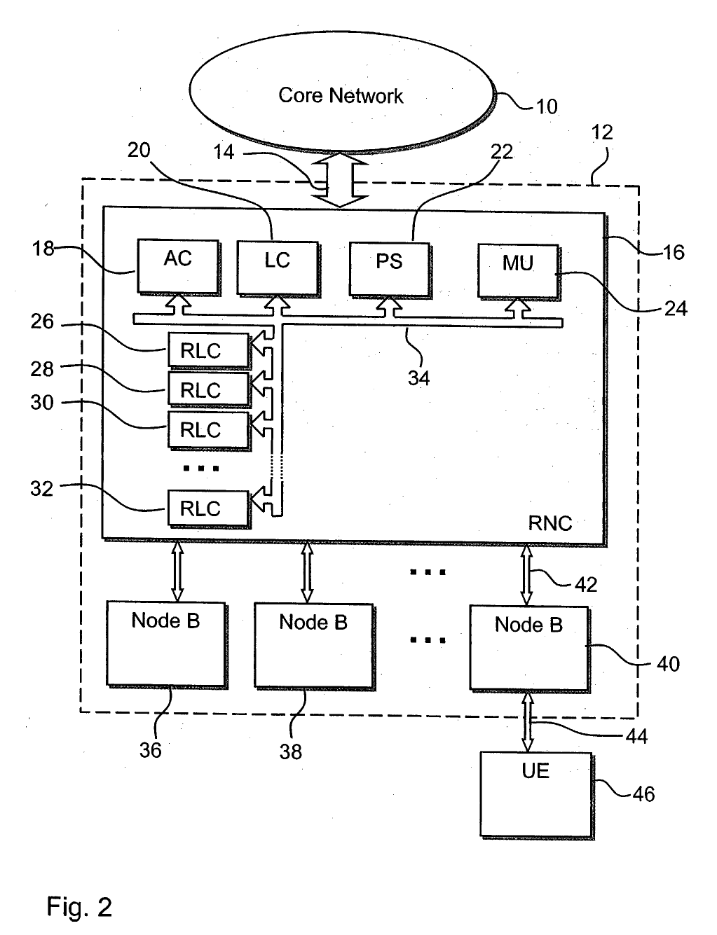

FIG. 2 shows a simplified block diagram of a centralized RAN network structure comprising a RNC controller according to the present invention. The diagram represents a UTRAN (Universal Terrestrial Radio Access Network) according to the current 3G standard.

A core network 10 connected a RA network 12 is shown without any structural detail. Core network 10 and RAN 12 are connected through an lub/lur interface 14. The connection between CN 10 and RAN 12 is established through high-bandwidth physical links, for instance by using copper or glass fiber cables. The high bandwidth is indicated by a wide arrow 14 for the lub/lur interface.

The RAN 12 has a radio network controller (RNC) 16 terminating the lu interface 14. Different functional units of RNC 16 are shown in FIG. 2. The structure shown is strongly simplified to reflect only functional aspects of the RNC which are relevant for the invention. Of relevance for the present invention is primarily the Radio Resource Management functionality of the RNC 16. For this, RNC 16 comprises an admission control unit 18, a load control unit 20, and a packet scheduling unit 22. The functionality of these units is basically known in the art, as described with reference to the background of the present invention. In addition to these units, a monitoring unit 24 is provided.

For buffering downlink data packets RNC 16 further comprises a number of radio link control (RLC) buffer memory blocks, four of which are shown at positions 26 to 32.

Interconnection of the functional units of RNC 16, indicated by arrow 34, allows signal exchange and data transport between them. Communication of the functional units of RNC 16 with network elements that are external to RNC 16 uses links and protocols known in the art, unless stated otherwise herein.

RNC 16 communicates with a number of Node B nodes, three of which are shown at positions 36, 38, and 40. A user equipment. Communication takes places across an lub interface 42.

The Node B nodes, such as Node B 40, provide a radio link across an air interface 44, also known as Uu interface in the context of the UTRAN architecture, to attached user equipment, such as a mobile phone, shown by way of example at position 46. UE 46 forms one end point of a radio access bearer between an edge node (not shown) of CN 10 across the lu, lub and Uu interfaces 14, 42, and 44. The Uu interface provides a relatively small bandwidth.

The monitoring unit (MU) 24 comprised by RNC 16 ascertains a current value of a load parameter indicative of a downlink bit rate transmitted across Uu interface 44. For this, MU 24 communicates with a measurement unit (not shown) at Node B 40, providing such load data on request by MU 24 or according to a predetermined schedule. The measurement unit at the Node B 40 is per se known in the art and not described here in further detail. Each Node B is assumed to have a like measurement unit communicating with MU 24. MU 24 evaluates statistical functions such as a mean value and a variance based on the data received from Node B 40, that is, air interface load data related to a cell (not shown) served by Node B 40. The evaluation results in a maximum bit rate value that can be allocated to active and requested radio access bearers for a particular NRT service class and user group. Thus, a number of maximum bit rate values is determined, differentiated according to traffic class and user group. These values are communicated to packet scheduling (PS) unit 22.

PS unit 22 receives the data provided by MU 24. Based on these data, PS unit 22 schedules downlink data packets for active radio access bearers with a maximum bit rate smaller or equal to the respective maximum bit rate value ascertained by MU 24, pertaining to the requested traffic class and user group corresponding to an individual RAB. This value is also used for renegotiation of the RAB parameter “Maximum Bit Rate” with core network 10 for active RABs of the corresponding traffic class and user group, and for negotiation of this parameter with the CN 10 during the setup of a new RAB.

By quasi-continuously monitoring the air interface load and by providing a protocol for adapting the “Maximum Bit Rate” parameter to the current air interface load, the variance of the processing load and buffer usage at RNC 16 is reduced. This allows to avoid extreme load situations as much as possible.

FIG. 2 shows that the RLC buffering capacity is located at a central point in the RAN 12. This allows an efficient use of the RLC buffers 26 to 32. The Node B nodes 36 through 40 need not provide much buffering capacity since the RNC 16 provides an appropriate packet scheduling.

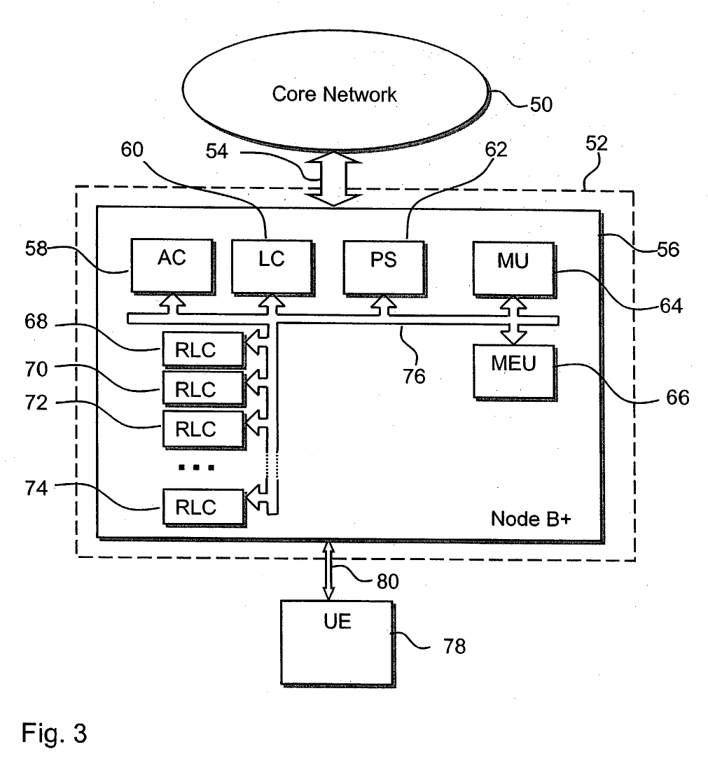

FIG. 3 shows a simplified block diagram of a distributed RAN network structure comprising a RAN access network element according to the present invention. The diagram represents a RAN according to a proposed distributed network structure.

A core network 50 connected a RA network 52 is shown without any structural detail. Core network 50 and RAN 52 are connected through a first interface 54. The connection between CN 50 and RAN 52 is established through high-bandwidth physical links, for instance by using copper or glass fiber cables. The high bandwidth is indicated by a wide arrow 54 representing the first interface.

RAN 52 has a Node B+ 56 terminating the first interface 14. In general, a plurality of Node B+ nodes are present in one RAN. However, for reasons of simplicity of the present description, only one Node B+ is shown in FIG. 3.

Different functional units of Node B+ 56 are shown in FIG. 3. The structure shown is strongly simplified to reflect only functional aspects of the Node B+ which are relevant for the invention. A comparison of the general structures of the RANs 12 and 52 shown in FIG. 2 and FIG. 3, respectively, reveals that Node B+ 56 combines functionalities that are distributed to a RNC and a Node B in the UTRAN 12 of FIG. 2. Of relevance for the present invention is primarily the Radio Resource Management functionality of the Node B+ 56. For this, Node B+ 56 comprises an admission control unit 58, a load control unit 60, and a packet scheduling unit 62. The functionality of these units is basically known in the art, as described with reference to the background of the present invention. In addition to these units, a monitoring unit (MU) 64 and a measuring unit (MEU) 66 are provided.

For buffering downlink data packets Node B+ 56 further comprises a number of radio link control (RLC) buffer memory blocks, four of which are shown at positions 68 to 74.

Interconnection of the functional units of Node B+ 56, indicated by arrow 76, allows signal exchange and data transport between them. Communication of the functional units of Node B+ 56 with network elements that are external to Node B+ 56 uses links and protocols known in the art, unless stated otherwise herein.

Node B+ 56 provides a radio link across a second interface 80, which is an air interface for communication with a user equipment 78. Air interface 80 represents an interface across a physical link that provides only a relatively small bandwidth. UE 78 forms one end point of a radio access bearer between an edge node (not shown) of CN 50 across the first and second interfaces 50 and 80, respectively.

The monitoring unit (MU) 64 comprised by Node B+ 56 ascertains a current value of a load parameter indicative of a downlink bit rate transmitted across air interface 80. For this, MU 64 communicates with measurement unit (MEU) 66, providing such load data on request by MU 64 or according to a predetermined schedule. Again, also measurement unit 66 is per se known in the art and not described here in further detail. Each Node B+ of RAN 52 is assumed to have a like measurement unit communicating with a MU like MU 64. MU 64 evaluates statistical functions such as a mean value and a variance based on the data received from MEU 66, that is, air interface load data related to a cell (not shown) served by Node B+ 56. The evaluation results in a maximum bit rate value that can be allocated to active and requested radio access bearers for a particular NRT service class and user group. Thus, a number of maximum bit rate values is determined, differentiated according to traffic class and user group. These values are communicated to packet scheduling (PS) unit 62.

PS unit 62 receives the data provided by MU 64. Based on these data, PS unit 62 schedules downlink data packets for active radio access bearers with a maximum bit rate smaller or equal to the respective maximum bit rate value ascertained by MU 64, pertaining to the requested traffic class and user group corresponding to an individual RAB. This value is also used for renegotiation of the RAB parameter “Maximum Bit Rate” with core network 50 for active RABs of the corresponding traffic class and user group, and for negotiation of this parameter with the CN 50 during the setup of a new RAB.

1. A method for scheduling the transport of data packets in a radio access bearer for a non-real-time downlink data transport service, comprising the steps of:
ascertaining an upper limit of a bit rate value that a radio interface comprised by the radio access bearer is currently able to provide for the non-real-time data transport service; and
scheduling the downlink data packets in the radio access bearer with a bit rate smaller than or equal to the upper limit bit rate value.

2. The method of claim 1, wherein the ascertaining step is performed repeatedly.

3. The method of claim 1, wherein the ascertaining step comprises a step of measuring at least one value of a load parameter of the radio interface.

4. The method of claim 1, wherein the ascertaining step comprises a step of requesting the current value of the load parameter of the radio interface from a database.

5. The method of claim 2, wherein the ascertaining step comprises determining a mean value of a plurality of previously ascertained bit rate upper limit values.

6. The method of claim 4, comprising an additional step of determining a variance of the plurality of previously ascertained bit rate upper limit values

7. The method of claim 1, wherein the ascertaining and scheduling steps are performed in dependence of a data transport service type and/or a user class allocated to the radio access bearer.

8. The method of claim 1, comprising after the ascertaining step and before the scheduling step a step of settting a “maximum bit rate”-parameter value allocated to the given service class of the radio access bearer equal to the maximum bit rate value.

9. The method of claim 8, comprising after the setting step a step of providing a current maximum bit rate parameter value allocated to the given service class of the radio access bearer as an input to the scheduling step, such that scheduling the downlink data packets in the radio access bearer is performed with a bit rate smaller than or equal to the maximum bit rate parameter value.

10. The method of claim 1, wherein the data transport service is performed based an Internet Protocol.

11. A radio access network element, comprising
a monitoring unit which ascertains an upper limit of a bit rate value that a radio interface comprised by a radio access bearer is currently able to provide for a non-real-time downlink data transport service; and
a packet scheduling unit which schedules downlink data packets for the non-real-time downlink data transport service in the radio access bearer with a bit rate smaller than or equal to the upper limit bit rate value.

12. A radio access network, comprising a network element according to claim 11.

13. The radio access network of claim 12, comprising a plurality of transceiver stations communicating with the radio access network element.

14. The radio access network of claim 12, comprising one transceiver station communicating with the radio access network element.
